(19) United States
(12) Patent Application Publication
(10) Pub. No.: US 2021/0407287 A1
(43) Pub. Date: Dec. 30, 2021

(54) TRAFFIC MANAGEMENT SYSTEM AND TRAFFIC MANAGEMENT METHOD INCLUDING PORTABLE TRAFFIC CONTROLLER

(71) Applicant: Siemens Mobility, Inc., New York, NY (US)

(72) Inventor: Tung Thanh Ly, Pflugerville, TX (US)

(21) Appl. No.: 16/917,353

(22) Filed: Jun. 30, 2020

(51) Int. Cl. G08G 1/0955; G08G 1/07; B64C 39/02; H04W 4/30

(52) U.S. Cl. CPC G08G 1/0955; G08G 1/07; B64C 39/024; B64C 2201/042; B64C 2201/128; B64C 2201/145; H04W 4/30

(57) ABSTRACT

A traffic management system includes a portable traffic controller unit with a traffic control module and a processor, integrated traffic signal plans and a traffic signal, and an unmanned aerial vehicle (UAV) including a global positioning system unit, wherein the UAV is configured to transport the portable traffic controller unit to a location with a stationary traffic signal controlled by a roadside traffic controller, wherein the portable traffic controller unit is configured to communicate with the roadside traffic controller to temporarily halt operation of the stationary traffic signal, and wherein the portable traffic controller unit is configured to assume traffic control at the location.

### BACKGROUND

### 1. Field

Aspects of the present disclosure generally relate to traffic management systems and associated methods including a portable traffic controller.

### 2. Description of the Related Art

Traffic control systems are used to govern operation of traffic signals at signaled intersections using signal plans. Traffic control systems comprise a traffic controller, wherein the traffic control system may simply be referred to as traffic controller. Traffic controllers traditionally either operate in isolation or are monitored and controlled by a central control system that communicates with the traffic controller. For traffic controllers that operate in isolation, the signal plans that govern operation of the traffic signals may be manually entered and may be modified through a user interface on the traffic controllers. For traffic controllers that are monitored and controlled by a central control system, signal plans for the traffic signals may be entered and modified through the central control system.

Traffic signals, such as for example traffic lights located at an intersection, can malfunction due to for example natural disaster, bad weather, power outage or traffic controller malfunction which causes the traffic lights to flash or not work at all. Such traffic light malfunction causes traffic jams that lead to waiting time and loss of money, resources, pollution, etc. depending on how quickly a responsible entity, such as a City or State's Department of Transportation, send repair technicians to the scene to repair the traffic signals/traffic controller. Sometimes, it may take several hours or days to bring the traffic lights back to normal operation, especially when the traffic lights are at certain locations that are difficult to get to in a short time.

### SUMMARY

A first aspect of the present disclosure provides a traffic management system comprising: a portable traffic controller unit comprising a traffic control module with at least one processor, integrated traffic signal plans and at least one traffic signal, and an unmanned aerial vehicle (UAV) comprising a global positioning system (GPS) unit, wherein the UAV is configured to transport the portable traffic controller unit to a location comprising a stationary traffic signal controlled by a roadside traffic controller, wherein the portable traffic controller unit is configured to communicate with the roadside traffic controller to temporarily halt operation of the stationary traffic signal, and wherein the portable traffic controller unit (130, 200) is configured to assume traffic control at the location.

A second aspect of the present disclosure a portable traffic controller unit comprising at least on traffic signal, a traffic control module comprising at least one processor configured to control operation of the at least one traffic signal based on traffic signal plans stored in a memory, a network interface for communicating with a roadside traffic controller, wherein the portable traffic controller unit is configured to communicate with the roadside traffic controller, via the network interface, to temporarily halt traffic control, and wherein the portable traffic controller unit is configured to assume the traffic control.

A third aspect of the present disclosure provides a method for managing traffic comprising transporting a portable traffic controller unit by a first unmanned aerial vehicle (UAV) to a location comprising a roadside traffic controller and a stationary traffic signal providing traffic control at the location, communicating, by the portable traffic controller unit, with the roadside traffic controller to temporarily halt the traffic control at the location, and assuming and performing the traffic control by the portable traffic controller unit at the location.

### BRIEF DESCRIPTION OF THE DRAWINGS

FIG. 1 illustrates a schematic diagram illustrating an intersection and a traffic management system in accordance with an exemplary embodiment of the present disclosure.

FIG. 2 illustrates a schematic diagram of a portable traffic controller unit in accordance with an exemplary embodiment of the present disclosure.

FIG. 3 illustrates a schematic diagram of a solar power generating UAV in connection with a traffic management system in accordance with an exemplary embodiment of the present disclosure.

FIG. 4 illustrates a flow chart of a method for managing traffic in accordance with an exemplary embodiment of the present disclosure.

### DETAILED DESCRIPTION

To facilitate an understanding of embodiments, principles, and features of the present disclosure, they are explained hereinafter with reference to implementation in illustrative embodiments. In particular, they are described in the context of being a traffic management system, associated method and traffic controller. Embodiments of the present disclosure, however, are not limited to use in the described devices or methods.

The components and materials described hereinafter as making up the various embodiments are intended to be illustrative and not restrictive. Many suitable components and materials that would perform the same or a similar function as the materials described herein are intended to be embraced within the scope of embodiments of the present invention.

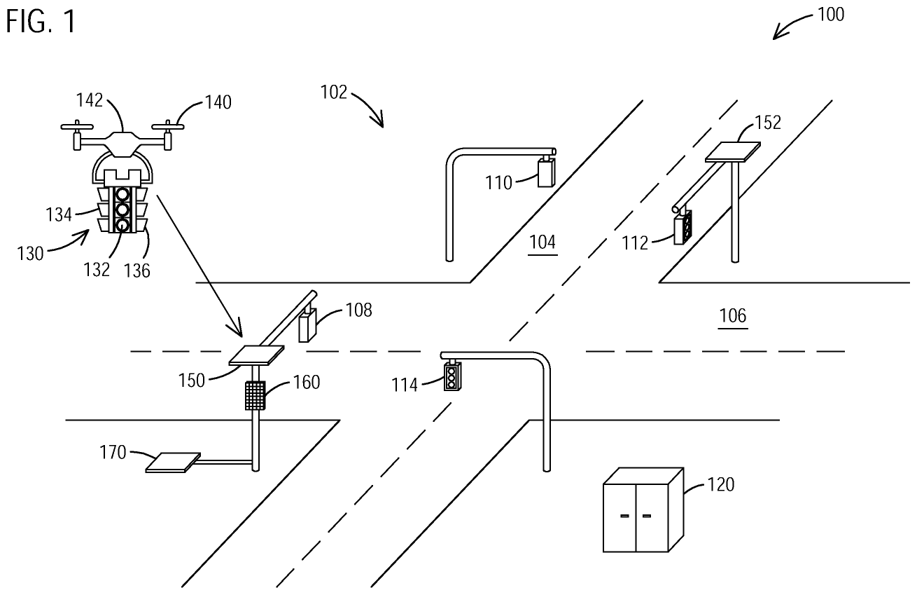

FIG. 1 illustrates a schematic diagram illustrating an intersection 102 and a traffic management system 100 in accordance with an exemplary embodiment of the present disclosure.

As illustrated, intersection 102 of a first street 104 and a second street 106 includes multiple traffic signals 108, 110, 112, 114 that are configured to control the flow of vehicles and/or pedestrians through the intersection 102. Traffic signals 108, 110, 112, 114 are herein also referred to as traffic lights. The traffic lights 108, 110, 112, 114 are controlled by a traffic controller 120. The traffic controller 120 can be autonomous or can be connected to a network. The network may be for example a private or secure network that is connected to the traffic controller 120 by a fiber optic cable, copper wire, a cellular modem or other wireless network, or by other suitable means. The traffic controller 120 may receive signal control plans via the network which are used to govern the operation of the traffic signals 108, 110, 112, 114. If the traffic controller 120 is operated autonomously, signal control plans may have been previously loaded and stored in the traffic controller 120. The traffic controller 120 is typically housed in a large metal cabinet, known as “traffic controller cabinet” or “TCC”, typically located in proximity to the intersection 102. The traffic controller 120 is herein referred to as roadside traffic controller 120 which means that the traffic controller 120 is permanently installed at a road or an intersection to provide traffic control in combination with the stationary traffic lights 108, 110, 112, 114. It should be noted that intersection 102 may comprise other traffic signals or signs such as for example railroad signals etc. It should be further noted that components of the intersection 102 and traffic management system 100 are only illustrated schematically and are not drawn to scale.

As mentioned before, traffic signals, such as for example traffic signals 108, 110, 112, 114 of intersection 102, sometimes malfunction due to for example natural disaster, bad weather, power outage or traffic controller malfunction which causes the traffic lights 108, 110, 112, 114 to flash or not work at all. Such traffic light malfunction causes traffic jams that lead to waiting time and loss of money, resources, pollution, etc. depending on how quickly a responsible entity, such as a City or State's Department of Transportation, send repair technicians to the scene to repair the traffic signals/traffic controller.

The traffic management system 100 described herein provides a fast response and interim solution for traffic control when the traffic signals 108, 110, 112, 114 and/or the traffic controller 120 fail or malfunction.

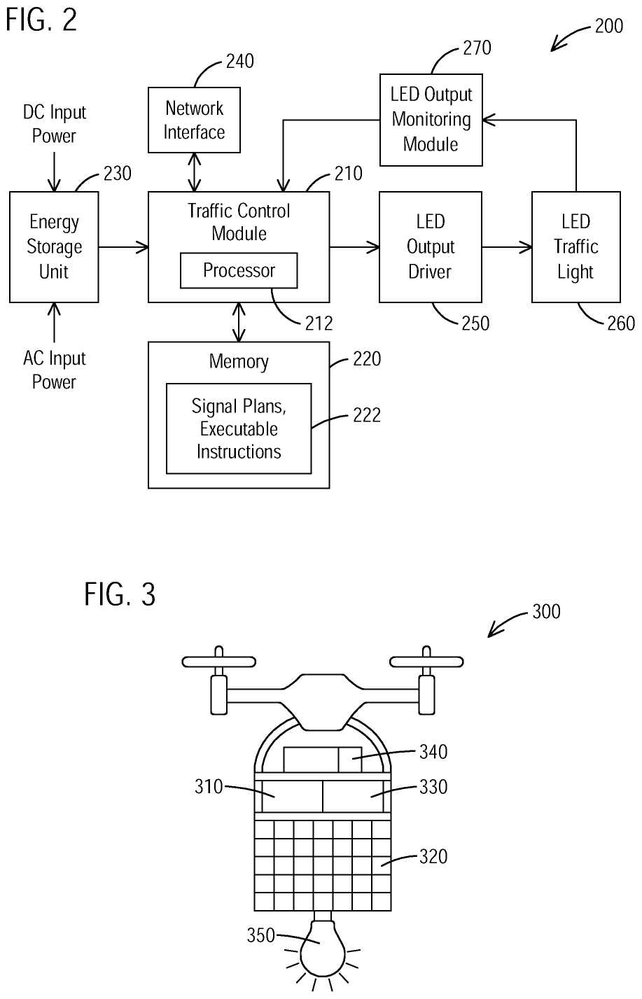

In an exemplary embodiment, the traffic management system 100 comprises a portable traffic controller unit 130 comprising a traffic control module with at least one processor, integrated traffic control software and at least one traffic signal 132, also referred to as traffic light 132. The portable traffic controller unit 130 may herein be referred to as simply portable unit 130. In an example, the portable unit 130 may comprise more than one traffic light 132, for example two, three or four traffic signals, wherein FIG. 1 partly illustrates further traffic lights 134, 136. The traffic control module can be arranged in a center of the portable traffic controller unit 130, wherein the one or more traffic lights 132, 134, 136 etc. are arranged adjacent to the traffic control module. If there is more than one traffic light 132, the traffic lights can be arranged in a successive manner around the traffic control module thereby covering the module. It should be noted that other arrangements of the portable traffic controller unit 130 are conceivable, for example that the traffic control module is arranged in a top section of the unit 130 and the traffic light 132 is arranged below the control module. The portable traffic controller unit 130 will be described in more detail with reference to FIG. 2.

The traffic management system 100 further comprises an unmanned aerial vehicle (UAV) 140 comprising a global position system (GPS) unit 142. The UAV 140 is herein also simply referred to as drone 140. The UAV or drone 140 is an aircraft without a human pilot on board (unmanned). UAVs are a component of an unmanned aircraft system (UAS) which include a UAV, a ground-based controller, and a system of communications between the UAV and the ground-based controller. The flight of UAVs may operate with various degrees of autonomy: either under remote control by a human operator or autonomously by onboard computers.

The drone 140 is configured to transport, e.g. fly, the portable traffic controller unit 130 to a location comprising a stationary traffic signal controlled by a roadside traffic controller. In our example, the drone 140 transports, e.g. flies, the portable traffic controller unit 130 to the intersection 102, where traffic signals 108, 110, 112, 114 are located. The portable unit 130 is configured to communicate with the roadside traffic controller 120 to temporarily halt or stop operation, for example to halt controlling or flashing the stationary traffic signal(s) 108, 110, 112, 114, and wherein the portable unit 130 is configured to assume traffic control at the intersection 102.

In an example, when traffic control at the intersection 102 is malfunctioning or failing, for example because one or more of the traffic signals 108, 110, 112, 114 and/or the roadside traffic controller 120 are faulty, a solution for temporary traffic control is provided by utilizing the portable traffic controller unit 130. As soon as the respective authority is aware of a problem or issue with traffic control at the intersection 102, drone 140 carrying the portable traffic controller unit 130 is dispatched to the intersection 102. The drone 140 can fly autonomously to the intersection 102 using its GPS module 142. The location of the intersection 102 can be programmed into the GPS module 142 at the time of operation of the drone 140, or many different locations of intersections may have already be pre-programmed into the GPS module 142 and the specific location can then be selected at the time.

In an embodiment, the drone 140 flies the portable traffic controller unit 130 to a landing pad 150, also referred to as docking pad 150, located at or in proximity to the intersection 102, specifically at or in proximity to one of the traffic signals 108, 110, 112, 114. For example, the landing pad 150 is located on top of a post or pole of one of the traffic signals 108, 110, 112, 114, for example traffic signal 108. The landing pad 150 is the place where the portable traffic controller unit 130 lands and docks for traffic control at the intersection 102. This means that the landing pad 150 needs to be in a location where the traffic lights 132, 134, 136 of the portable unit 130 are clearly visible for the traffic participants such as motorists, cyclists and pedestrians. Other locations for the landing pad 150 are conceivable, such as for example a separate post installed at a suitable location.

The portable traffic controller unit 130 and the traffic controller 120 each comprise a network interface for wireless communication. Wireless communication can be performed via wireless networks such as for example wireless LAN over Internet access point, cellular/mobile network(s), for example standard LTE (3G, 4G, 5G), or other radio technology (Bluetooth, Zigbee). Depending on which wireless network is used, the portable traffic controller unit 130 and traffic controller 120 each comprise a corresponding network interface.

The portable traffic controller unit 130 is configured to communicate with the traffic controller 120. Specifically, the portable traffic controller unit 130 communicates to the traffic controller 120 to temporarily halt or pause operation, e.g. control of the traffic lights 108, 110, 112, 114. For example, the portable traffic controller unit 130 may override commands of the roadside traffic controller 120 to turn off any (yellow) flashing of the traffic lights 108, 110, 112, 114, or to override or delete other signals from the traffic controller 120 to the traffic lights 108, 110, 112, 114.

Instead of the roadside traffic controller 120, the portable unit 130 will assume/take over traffic control at the intersection 102. Specifically, the traffic control module with the at least one processor and integrated traffic control software including signal plans operates the onboard traffic lights 132, 134, 136 to provide traffic control at the intersection 102. The portable traffic control unit 130 provides traffic control as long as necessary, for example until the roadside controller 120 and/or traffic lights 108, 110, 112, 114 are repaired. When the roadside controller 120 and/or traffic lights 108, 110, 112, 114 are repaired and function properly again, the portable traffic controller unit 130 is removed from the intersection 102 utilizing the drone 140. While the portable traffic controller unit 130 is in use at the intersection 102, the drone 140 may leave the intersection 102 so that it can be used for other tasks. When the portable traffic controller unit 130 is ready to be picked up, the drone 140 is dispatched to the intersection 102 and picks up the portable unit 130. The portable traffic controller unit 130 can be returned to a facility of the respective authority or can be transported to another location for traffic control.

In another exemplary embodiment, the traffic management system 100 comprises a plurality of portable traffic controller units 130. Multiple portable traffic controller units 130 may be necessary at large or complex intersections with many traffic signals where only one portable traffic controller unit 130 may not be enough. In a scenario, a first portable traffic controller unit 130 may provide traffic control for vehicles, wherein a second portable traffic controller unit 130 may provide traffic control for pedestrians. In our example, the first portable traffic controller unit 130 is positioned at landing pad 150 providing traffic control for vehicles. A second portable traffic controller unit 130 can be positioned at a second landing pad 152 providing traffic control for pedestrians.

In an example including multiple portable traffic controller units 130, a first portable traffic controller unit 130 is configured as master controller unit and a second (third, fourth, etc.) portable traffic controller unit 130 is configured as slave controller unit Each portable traffic controller unit 130 comprises a network interface for wireless communication with each other. The master controller unit is configured to communicate with the roadside traffic controller 120, for example to communicate with the traffic controller 120 to (temporarily) halt or pause traffic operation so that the portable units 130 can take over traffic control. Each portable unit 130 comprises a traffic control module with at least one processor and traffic control software including signal plans for traffic control. The respective traffic control software including signal plans is pre-programmed into the respective portable unit 130 for traffic control at the specific location. Further, the master controller unit can be configured to communicate or instruct the one or more slave controller units during traffic control.

The plurality of portable traffic controller units 130 may be transported by a plurality of drones 140 at the same time or may be transported one after another by a drone 140 to a specific location, such as intersection 102.

FIG. 2 illustrates a block diagram of a portable traffic controller unit 200 in accordance with an exemplary embodiment of the present disclosure. In an example, the portable traffic controller unit 130 of FIG. 1 can be embodied for example as portable traffic controller unit 200.

The portable traffic controller unit 200, herein also simply referred to as portable unit 200, comprises a traffic control module 210 including at least one processor 212 and traffic control software including signal plans 222 stored in memory 220 and an energy storage unit 230 (power source). The at least one processor 212 may include one or more processing units. The memory 220 may include a suitable type of memory selected from a wide variety of memory devices including volatile and non-volatile memory devices.

The portable unit 200 further comprises a network interface 240 for communicating with one or more other devices, such as another traffic controller, for example a roadside traffic controller 120, see FIG. 1, or another portable unit 200. As described before, wireless communication can be performed via wireless networks such as for example wireless LAN (over Internet access point), cellular/mobile network(s) for example standard LTE (3G, 4G, 5G) or other radio technology (Bluetooth, Zigbee). Depending on which wireless network is used, the portable unit 200 comprises one or more corresponding network interfaces 240.

The portable traffic controller unit 200 further comprises one or more traffic (portable) light(s) 260, which can be embodied as light emitting diode (LED) traffic light(s) 260. The portable unit 200 comprises a LED output driver 250 for driving the LED traffic light(s) 260. Further, the portable unit 200 comprises a LED output monitoring module 270 for monitoring the LED traffic light(s) 260 to make sure that the traffic light(s) 260 work properly. The LED output monitoring module 270 constantly monitors the LED light(s) 260 for loss of light output, light conflicts or issues with the LED lights. Although nowadays LED lights are often used for traffic lights, it should be noted that the traffic light(s) 260 may comprise incandescent lamps.

The portable traffic controller unit 200 requires power for operation and comprises energy storage unit 230. In an example, the energy storage unit 230 is configured as rechargeable energy storage unit and powers all necessary equipment of the portable unit 200. The energy storage unit 230 comprises one or more rechargeable batteries. Equipment that needs power includes the traffic control module 210 with the at least one processor 212, the onboard traffic light(s) 260 and optionally further circuits of the portable traffic controller unit 200. In another example, the energy storage unit 230 may also be used to power the drone 140 and vice versa (drone power supply used to power the portable unit 200) if necessary.

The energy storage unit 230 is configured to receive and store direct current (DC) input power and/or alternating current (AC) input power. The portable unit 200 can comprise corresponding power converters, for example a AC-DC power converter converting AC into DC if the portable unit 200 operates with DC power.

In an exemplary embodiment, the landing pad(s) 150, 152, see FIG. 1, comprise output power support from the stationary traffic signal 108, 114, wherein the portable unit 200 is configured to receive output power from the traffic signal 108, 114 via the output power support of the landing pad 150, 152. In this case, the portable unit 200 comprises an input power docking adapter(s) and receives AC input power from the traffic signal 108, 114 if the traffic signal 108, 114 is still being powered by the roadside traffic controller 120. For example, when the traffic signal 108, 114 is flashing, AC power is still available and can be used to power and/or charge the portable unit 200. Received AC power can then be converted into DC power using an AC-DC power converter for operating the portable unit 200. In case there is no AC power from the respective traffic signal 108, 114 available, for example in case of a power outage at the intersection 102, the portable unit 200 may use its own energy (DC power) stored in the energy storage unit 230.

In another example, the portable unit 200 may receive power from a solar power generator 160, see FIG. 1, located at or in proximity to the portable unit 200, for example at or in proximity to the stationary traffic signal 108, 114 where the portable unit 200 (130) is positioned for traffic control. The solar power generator 160 can provide output power to the portable traffic controller unit 200 (130). For example, the landing pad 150 can be electrically coupled, for example using cables, to the solar power generator 160, wherein the power can then be transferred to the portable unit 200 (130) via the landing pad 150.

In another example, a solar power generating UAV (drone) can provide output power to the portable traffic controller unit 130, 200. Further details with respect to a solar power generating drone 300 will be described with reference to FIG. 3.

In another exemplary embodiment, the portable unit 200 can be configured as smart and/or artificial intelligent. For example, the portable unit 200 may comprise one or more visual sensors, such as cameras. The visual sensors can be used to monitor traffic at the respective intersection, such as intersection 102, and control the traffic in accordance with current traffic monitored at the intersection. For example, the portable unit 200 can monitor the number of vehicles driving on roads 104, 106, using visual sensors, and modify or adjust traffic control according the current traffic situation. For example, if the portable unit 200 detects that there are no or very few vehicles travelling on road 104, but many vehicles on road 106, the portable unit 200 can decide and control the traffic such that the traffic lights 110, 114 of road 106 remain green for a longer period, while traffic lights 108, 112 remain red (and vice versa). Further, the portable unit 200 can comprise corresponding traffic control instructions (software) such that the traffic control module 210 can control the traffic accordingly. In other words, the portable unit 200 is configured to at least partially control traffic in an autonomous manner. The traffic control module 210 may further comprise machine learning algorithms or software, such as for example unsupervised learning algorithms, stored in memory 220, for improving or modifying the traffic control in the autonomous manner.

Those of skill in the art will recognize that not all details are shown in the simplified block diagram of FIG. 2. The processor 212 may be configured to perform only the processes described herein or can also be configured to perform other processes for the operation and management of the portable traffic controller unit 200. The various components of the traffic controller 200 and the software thereon, may be configured as separate elements connected to communicate with each other or two or more of these components could be integrated into a single device.

FIG. 3 illustrates a schematic diagram of a solar power generating UAV 300 in connection with a traffic management system in accordance with an exemplary embodiment of the present disclosure. The traffic management system can be for example the traffic management system 100 described with reference to FIG. 1.

There are electric powered devices or machines that need to operate in locations where there is no electrical power available. The delivery of power to such a location can sometimes take a long time due to for example accessibility issues, such as bad road conditions. A solution is for the user of the device to wait for someone to deliver the batteries or a power generator from another location by foot or a vehicle, or the user has to travel to a certain location to get another source of power.

The solar power generating UAV 300, herein also referred to as solar drone 300, comprises capabilities of generating, storing and providing electrical power to another device, such as portable unit 200, see FIG. 2.

The solar drone 300 described herein includes a solar power generator 310 that can generate electrical power using for example solar panels 320, store the electrical power in an energy storage 330 and provide the electrical power to another device, such as for example a portable traffic controller unit 200, see FIG. 2. The solar drone 300 generates and stores DC power using sun light.

In an example, the solar drone 300 comprises a built-in or integrated GPS 340, wherein the GPS 340 can be programmed to fly the solar drone 300 to a specific location or the solar drone 300 can be remote controlled by an operator. The flying feature of the solar drone 300 speeds up delivery over air and it is faster than delivery by foot or other vehicles on the road.

In another embodiment, the solar drone 300 can comprise a light source 350 to illuminate or brighten for example a remote area at night, as chosen by the user. The light source 350 can comprise LED lights and/or incandescent light bulbs. Further, the light source 350 can be adapted to turn into a portable heater when used in a low temperature environment.

The solar drone 300 combines solar energy technology and drone technology. The solar drone 300 further comprises at least one processor which can comprise different configurations. For example, the at least one processor can be configured to provide auto landing, auto docking, autonomous flying, and auto setting its solar panel(s) 320 for best sunlight capturing. In another example, the solar drone 300 may be used as a mobile spotlight or a mobile heater in case of search and rescue operation or in emergency situations.

In an example, the solar drone 300 can be used in connection with the portable traffic controller unit 130, 200 of FIG. 1 and FIG. 2. The solar drone 300 can provide power to the portable unit 130, 200. The solar drone 300 may land and dock at a solar landing pad 170 at the intersection 102, see FIG. 1. The solar landing pad 170 is in proximity to a landing pad 150, 152 of the portable unit 130, 200. For example, the solar landing pad 170 can be electrically connected, via cables, to the landing pad 150 such that electrical power provided by the solar drone 300 can be transferred to the landing pad 150 and used by the portable unit 130. While providing power to the portable unit 130, 200, the solar drone 300 can generate more electric power using its solar panel(s) 320 and solar power generator 310. The power of the solar drone 300 can be used to operate the portable unit 130, 200 and/or charge the energy storage unit 230 of the portable unit 130, 200. In an embodiment, both solar drone 300 and portable unit 130, 200 operate with DC power so that no power converter is needed.

Other applications for the solar drone 300 include for example DC powered (roadside) traffic cabinets and LED traffic lights, street lights, spotlights, camping lights and camping heaters, road side units (RSU) for connected vehicles, portable electric power stations, portable charging stations for electric scooters, electric bikes, electric vehicles, phones, etc.

It should be noted that the solar drone 300 is only shown schematically to illustrate the features and elements of the solar drone 300 and certain features may not be drawn to scale and/or not shown in detail.

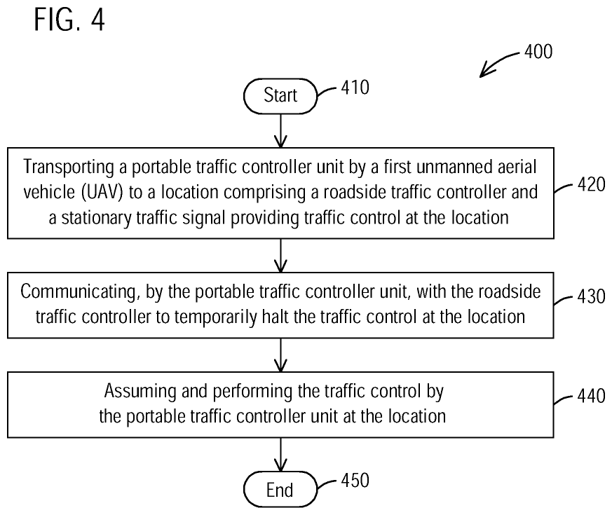

FIG. 4 illustrates a flow chart of a method 400 for managing traffic in accordance with an exemplary embodiment of the present disclosure. While the method 400 is described as a series of acts that are performed in a sequence, it is to be understood that the method 400 may not be limited by the order of the sequence. For instance, unless stated otherwise, some acts may occur in a different order than what is described herein. In addition, in some cases, an act may occur concurrently with another act. Furthermore, in some instances, not all acts may be required to implement a methodology described herein.

The method 400 relates to the traffic management system 100 and portable traffic controller unit 200 as describes herein. Features and elements of the method 400 that are not described in further detail, are described in connection with system 100 and portable unit 200, see FIG. 1 or FIG. 2.

The method 400 may start at 410 and may include an act 420 of transporting a portable traffic controller unit 130, 200 by a first unmanned aerial vehicle (drone) 140 to a location comprising a roadside traffic controller 120 and a stationary traffic signal 108, 110, 112, 114 providing traffic control at the location. Act 430 includes communicating, by the portable traffic controller unit 130, 200, with the roadside traffic controller 120 to temporarily halt the traffic control at the location. The method 400 may also include an act 440 of assuming and performing the traffic control by the portable traffic controller unit 130, 200 at the location. At 450, the method 400 may end.

In an embodiment, the first UAV (drone) 140 comprise a global positioning system (GPS) unit 142 and transports the portable traffic controller unit 130, 200 autonomously to the location using the GPS unit 142.

As previously described, for example with reference to FIG. 2, the portable traffic controller unit 200 comprises at least on traffic signal 260, a traffic control module 210 comprising at least one processor 212 configured to control operation of the at least one traffic signal 260 based on signal control plans 222 stored in memory 220, and a network interface 240 for communicating with the roadside traffic controller 120 and/or further portable units 200 via a wireless communication network.

The method 400 for managing traffic further comprises docking, by the portable traffic controller unit 200, at a landing pad 150, 152 at or in proximity to the stationary traffic signal, and transferring output power from the stationary traffic signal to the portable traffic controller unit 130, 200 and/or the drone 140 via the landing pad 150, 152. The method 400 may further comprise transferring power from a solar power generator 160 to the portable traffic controller unit 130, 200, wherein the solar power generator 160 is located at or in proximity to the stationary traffic signal. In another embodiment, the method 400 comprises transferring power from a solar power generating drone 300 to the portable traffic controller unit 130, 200, the solar power being provided by a second UAV 300, referred to as solar drone 300 and described with reference to FIG. 3.

It should be appreciated that the described method 400 may include additional acts and/or alternative acts corresponding to the features described previously with respect to the traffic management system 100, portable traffic controller unit 200 and solar drone 300 (see FIG. 1, FIG. 2 and FIG. 3).

The described traffic management systems and associated methods provide a fast solution to restore or establish traffic control at a location or intersection where a traffic controller or traffic signals are malfunctioning or failing. The responsible authority, such as the City or State's Department of Transportation, can respond quickly and send the portable traffic controller unit 200 using a drone 140 from a central station to the troubled location or intersection. The portable unit 200 can perform or provide traffic control as long as it is needed, i.e. until the traffic signals or traffic controller are repaired by technicians or repair personnel. This quick solution helps to reduce pollution, accidents, the loss of waiting time, money, resources. The portable unit 130, 200 can operate intelligently by itself or with a group of portable units 130, 200 as a network to control a more complex traffic situation.

Other applications of the portable traffic controller unit 130, 200 include for example utilizing the portable unit 130, 200 for controlling boat traffic or shipping traffic. For example, when boats enter or navigate a bay area or harbor, the portable unit 200, carried (flown) by the drone 140, can be used to lead or guide the boats through the bay area or harbor. The drone 140 with the portable unit 200 can fly next to the boat, visible to the captain or navigating crew, and steer or guide the boat. For example, the traffic light 260 of the portable unit 200 provides green light when the ship can move and red light when the ship needs to stop because of other ships or boats. It should be noted that further applications of the portable unit 130, 200 are conceivable with respect to road traffic, shipping traffic, bicycle traffic, pedestrian traffic, railroad traffic etc.

It should be appreciated that acts associated with the above-described methodologies, features, and functions (other than any described manual acts) may be carried out by one or more data processing systems, such as for example traffic control module 210, via operation of at least one processor 212, of portable unit 200, or at least one processor of solar drone 300.

As used herein a processor corresponds to any electronic device that is configured via hardware circuits, software, and/or firmware to process data. For example, processors described herein may correspond to one or more (or a combination) of a microprocessor, CPU, or any other integrated circuit (IC) or other type of circuit that is capable of processing data in a data processing system. As discussed, the processor(s) that is/are described or claimed as being configured to carry out a particular described/claimed process or function may correspond to a CPU that executes computer/processor executable instructions stored in a memory in form of software and/or firmware to carry out such a described/claimed process or function. However, it should also be appreciated that such a processor may correspond to an IC that is hard wired with processing circuitry (e.g., an FPGA or ASIC IC) to carry out such a described/claimed process or function.

In addition, it should also be understood that a processor that is described or claimed as being configured to carry out a particular described/claimed process or function may correspond to the combination of the processor with the executable instructions (e.g., software/firmware apps) loaded/installed into a memory (volatile and/or non-volatile), which are currently being executed and/or are available to be executed by the processor to cause the processor to carry out the described/claimed process or function. Thus, a processor that is powered off or is executing other software, but has the described software installed on a data store in operative connection therewith (such as on a hard drive or SSD) in a manner that is setup to be executed by the processor (when started by a user, hardware and/or other software), may also correspond to the described/claimed processor that is configured to carry out the particular processes and functions described/claimed herein.

In addition, it should be understood, that reference to “a processor” may include multiple physical processors or cores that are configures to carry out the functions described herein. Further, it should be appreciated that a data processing system may also be referred to as a controller that is operative to control at least one operation.

It is also important to note that while the disclosure includes a description in the context of a fully functional system and/or a series of acts, those skilled in the art will appreciate that at least portions of the mechanism of the present disclosure and/or described acts are capable of being distributed in the form of computer/processor executable instructions (e.g., software and/or firmware instructions) contained within a data store that corresponds to a non-transitory machine-usable, computer-usable, or computer-readable medium in any of a variety of forms. The computer/processor executable instructions may include a routine, a sub-routine, programs, applications, modules, libraries, and/or the like. Further, it should be appreciated that computer/processor executable instructions may correspond to and/or may be generated from source code, byte code, runtime code, machine code, assembly language, Java, JavaScript, Python, Julia, C, C #, C++ or any other form of code that can be programmed/configured to cause at least one processor to carry out the acts and features described herein. Still further, results of the described/claimed processes or functions may be stored in a computer-readable medium, displayed on a display device, and/or the like.

1. A traffic management system comprising:
a portable traffic controller unit comprising a traffic control module with at least one processor, integrated traffic signal plans and at least one traffic signal, and
an unmanned aerial vehicle (UAV) comprising a global positioning system (GPS) unit,
wherein the UAV is configured to transport the portable traffic controller unit to a location comprising a stationary traffic signal controlled by a roadside traffic controller,
wherein the portable traffic controller unit is configured to communicate with the roadside traffic controller to temporarily halt operation of the stationary traffic signal, and
wherein the portable traffic controller unit is configured to assume traffic control at the location.

2. The traffic management system of claim 1, wherein the portable traffic controller unit and the roadside traffic controller each comprise a network interface for wireless communication.

3. The traffic management system of claim 1, further comprising:
a landing pad located at or in proximity to the stationary traffic signal comprising output power support from the stationary traffic signal, wherein the portable traffic controller unit is configured to land and dock on the landing pad and receive output power from the stationary traffic signal.

4. The traffic management system of claim 1, further comprising:
a solar power generator located at or in proximity to the stationary traffic signal, wherein the solar power generator provides output power to the portable traffic controller unit for operating the traffic control module and other electric circuits.

5. The traffic management system of claim 1, further comprising:
a solar power generating UAV providing output power to the portable traffic controller unit.

6. The traffic management system of claim 1, comprising:
a plurality of portable traffic controller units,
wherein a first portable traffic controller unit is configured as master controller unit and a second portable traffic controller unit is configured as slave controller unit, and
wherein the master controller unit is configured to instruct the slave controller unit during the traffic control at the location.

7. The traffic management system of claim 6, wherein each portable traffic controller unit comprises a network interface for communicating wirelessly with each other, and wherein the master controller unit is configured to communicate wirelessly with the roadside traffic controller.

8. The traffic management system of claim 6, wherein the master controller unit is configured to provide traffic control for vehicles, and wherein the slave controller unit is configured to provide traffic control for pedestrians.

9. A portable traffic controller unit comprising:
at least on traffic signal,
a traffic control module comprising at least one processor configured to control operation of the at least one traffic signal based on traffic signal plans stored in a memory,
a network interface for communicating with a roadside traffic controller,
wherein the portable traffic controller unit is configured to communicate with the roadside traffic controller, via the network interface, to temporarily halt traffic control, and
wherein the portable traffic controller unit is configured to assume the traffic control.

10. The portable traffic controller unit of claim 9, further comprising:
an energy storage unit for powering the traffic control module and further circuits of the portable traffic controller unit.

11. The portable traffic controller unit of claim 10, wherein the energy storage unit is configured to receive and store direct current (DC) input power and/or alternating current (AC) input power.

12. The portable traffic controller unit of claim 9, wherein the at least one traffic signal comprises a light emitting diode (LED) traffic light, and wherein the portable traffic controller unit further comprises a LED output driver for driving the LED traffic light and a LED output monitoring module for monitoring the LED traffic light.

13. The portable traffic controller unit of claim 9, wherein the network interface is configured as wireless network interface for wireless communication with the roadside traffic controller and/or a further portable traffic controller unit.

14. The portable traffic controller unit of claim 9, wherein the portable traffic controller unit is configured as master controller unit, the master controller unit being configured to communicate with one or more further portable traffic controller units configured as slave controller units, wherein the master controller unit is configured to instruct the slave controller units during traffic control at the location.

15. A method for managing traffic comprising:
transporting a portable traffic controller unit by a first unmanned aerial vehicle (UAV) to a location comprising a roadside traffic controller and a stationary traffic signal providing traffic control at the location,
communicating, by the portable traffic controller unit, with the roadside traffic controller to temporarily halt the traffic control at the location, and
assuming and performing the traffic control by the portable traffic controller unit at the location.

16. The method for managing traffic of claim 15, wherein the UAV comprises a global positioning system (GPS) unit and transports the portable traffic controller unit autonomously to the location using the GPS unit.

17. The method for managing traffic of claim 15, wherein the portable traffic controller unit comprises
at least on traffic signal,
a traffic control module comprising at least one processor configured to control operation of the at least one traffic signal based on signal plans stored in a memory, and
a network interface for communicating with the roadside traffic controller via a wireless communication network.

18. The method for managing traffic of claim 15, further comprising:
docking, by the portable traffic controller unit, at a landing pad at or in proximity to the stationary traffic signal, and
transferring output power from the stationary traffic signal to the portable traffic controller unit and/or the UAV via the landing pad.

19. The method for managing traffic of claim 15, further comprising:
transferring power from a solar power generator to the portable traffic controller unit, the solar power generator being located at or in proximity to the stationary traffic signal.

20. The method for managing traffic of claim 15, further comprising:
transferring power from a second UAV comprising a solar power generator to the portable traffic controller unit.
